(19) United States
(12) Patent Application Publication
(10) Pub. No.: US 2021/0245312 A1
(43) Pub. Date: Aug. 12, 2021

(54) CONTROL ARM ASSEMBLY MECHANISM AND CONTROL ARM ASSEMBLY METHOD

(71) Applicant: SHIH HSIANG AUTO PARTS CO., LTD., Taichug City (TW)

(72) Inventors: Che-Hung CHOU, TAICHUNG CITY (TW); Kun-Liang CHOU, TAICHUNG CITY (TW)

(21) Appl. No.: 16/852,098

(22) Filed: Apr. 17, 2020

(30) Foreign Application Priority Data
Feb. 7, 2020 (TW) 109103929

(51) Int. Cl. B23P 19/02; B23P 19/00; B23P 19/04

(52) U.S. Cl. CPC B23P 19/02; B23P 19/04; B23P 19/006

(57) ABSTRACT

A control arm assembly mechanism includes: a workbench having thereon a holder; a vertically pressing device disposed above the workbench and including a moving arm capable of moving toward and away from the holder; and two transversely pressing devices flanking the workbench and each including a moving arm capable of moving toward and away from the holder. The control arm assembly mechanism operates in such a manner to compress transversely and vertically a bushing placed on the workbench and thereby fit the bushing into a control arm.

### BACKGROUND OF THE INVENTION

### 1. Field of the Invention

The present disclosure relates to production of control arms for use in car suspension systems and, more particularly, to a control arm assembly mechanism and a control arm assembly method.

### 2. Description of the Related Art

Conventional control arms are important components in a car suspension system. The control arms vary in length, size and form, depending on automobile manufacturers, makes and models; however, every control arm comprises a metallic arm and a bushing. According to prior art, the metallic arm and the bushing are separately manufactured, and then the bushing is squeezed into a through hole at one end of the metallic arm by a conventional hydraulic or pneumatic stamping process. According to the prior art, the bushing is squeezed into a transitional jig by a first-instance compression process which is intended to reduce the outer diameter of the bushing in order for the bushing to be restrained by the jig. Then, a second-instance compression process is carried out to withdraw partially the bushing from the jig. Finally, both the jig and the bushing are placed on the through hole of the metallic arm to undergo a third-instance compression process so as to squeeze the bushing into the through hole of the metallic arm and remove the transitional jig. However, the prior art is not only complicated but also time-consuming and thus still has room for improvement.

### SUMMARY OF THE INVENTION

It is an objective of the present disclosure to provide an assembly mechanism dedicated to control arms to speed up and simplify assembly of the control arms.

In order to achieve the above and other objectives, the present disclosure provides a control arm assembly mechanism comprising: a workbench having thereon a holder for holding a target control arm; two transversely pressing devices flanking the workbench and each comprising a moving arm capable of moving toward and away from the holder; and a vertically pressing device disposed above the workbench and comprising a moving arm capable of moving toward and away from the holder. Therefore, the control arm assembly mechanism of the present disclosure performs the process of clamping a bushing and the process of squeezing the bushing into a metallic arm concurrently with the control arm assembly method of the present disclosure to thereby assemble control arms quickly and efficiently.

Preferably, the workbench has a through hole, and the moving arm of the vertically pressing device is disposed above the through hole.

Preferably, a buffer cylinder is disposed under the through hole of the workbench. The buffer cylinder comprises a cylinder body and a rod body. The rod body extends outward from the cylinder body to reach the through hole.

### BRIEF DESCRIPTION OF THE DRAWINGS

FIG. 1 is a perspective view of a control arm assembly mechanism of the present disclosure.

FIG. 2 is a front view of a workbench of the present disclosure.

FIG. 3 is a partial, enlarged perspective view of the control arm assembly mechanism of the present disclosure, showing a control arm on a holder of the workbench.

FIG. 4 is a top view of the workbench of the present disclosure, showing that the control arm is placed on the workbench.

FIG. 5 is a partial, enlarged perspective view of the present disclosure, showing that a control arm and a bushing are placed on the workbench.

FIG. 6 is a partial, enlarged perspective view based on FIG. 5, showing that moving arms of two transversely pressing devices move toward the holder and clamp the bushing.

FIG. 7 is a top view based on FIG. 6, showing that the moving arms of the two transversely pressing devices move toward the holder and clamp the bushing.

FIG. 8 is a partial, enlarged perspective view based on FIG. 5, showing that a moving arm of a vertically pressing device moves toward the holder and squeezes the bushing into the control arm.

### DETAILED DESCRIPTION OF THE PREFERRED EMBODIMENTS

The technical features of the present disclosure as described herein are not limited to specific structures, purposes and applications of the embodiments of the present disclosure. All technical terms used herein are exemplary, descriptive terms comprehensible to persons skilled in the art. Directional expressions used herein, such as “front,” “upward,” “downward,” “backward,” “leftward,” “rightward,” “top,” “bottom,” “in” and “outer,” are exemplary, descriptive terms which must be interpreted from a layman's perspective and must not be restrictive of the appended claims of the present disclosure.

Singular quantitative wording used in the appended claims of the present disclosure, such as “a,” “an,” “one” and “the,” must be interpreted in such a manner to include their plural forms. For example, the expression “a component” must be interpreted in such a manner to mean “one or more components” and include equivalent substitutes well-known among persons skilled in the art. All conjunctions used under similar conditions must be given the broadest interpretation. Specific shapes and structural features described herein and technical terms used herein must be interpreted in such a manner to encompass equivalent substitute structures or techniques which achieve the same functions as the specific structures described herein or technical terms used herein.

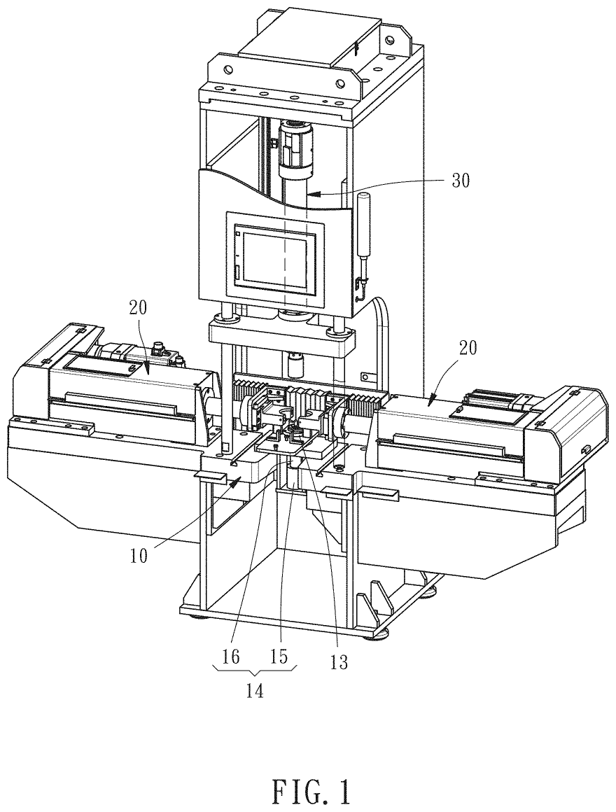

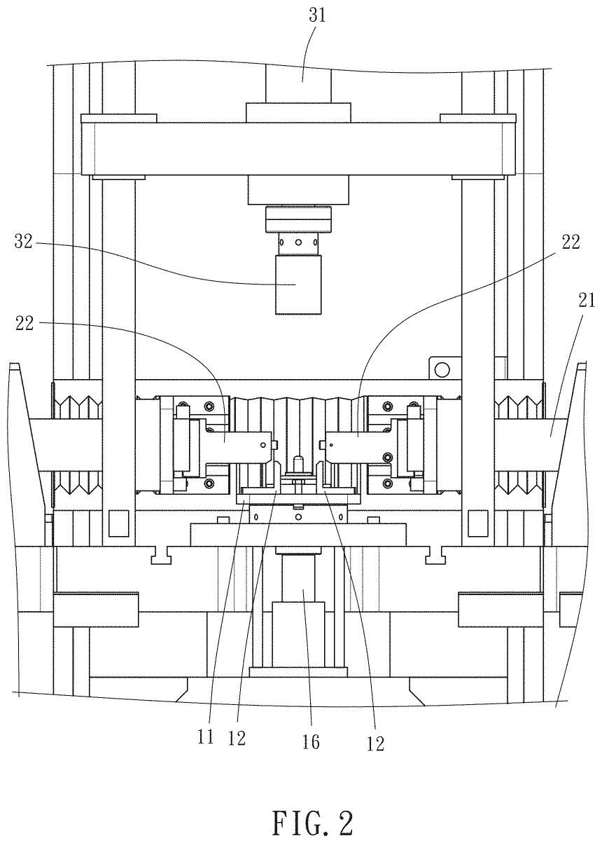

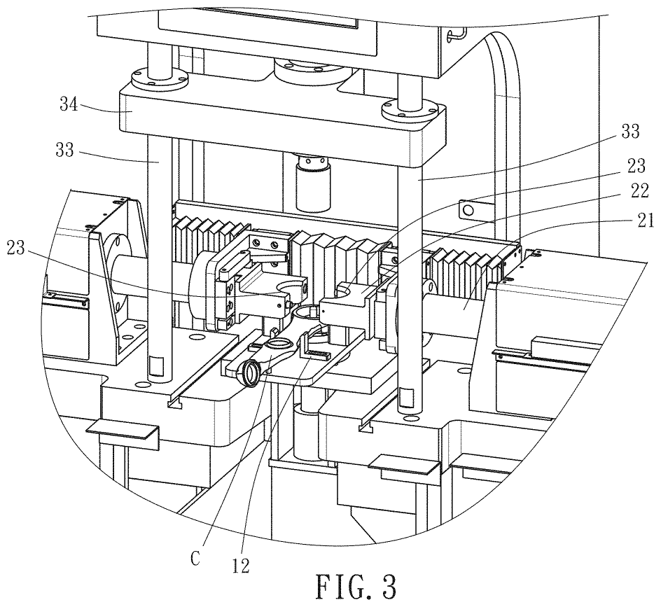

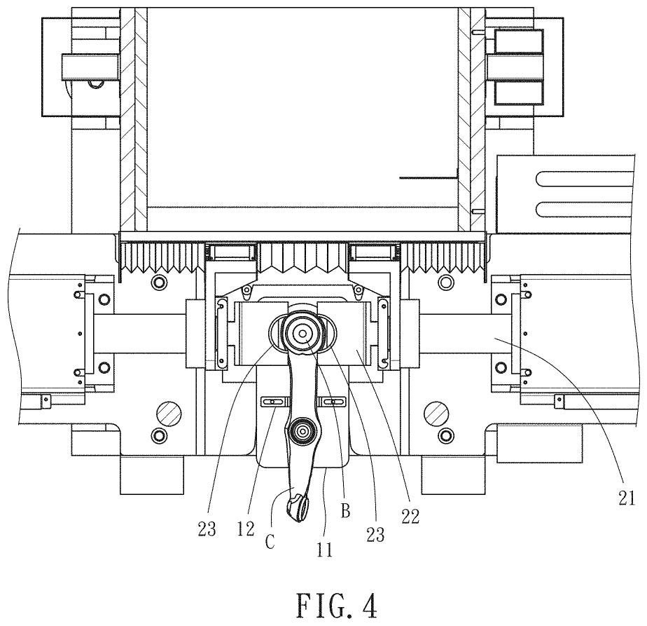

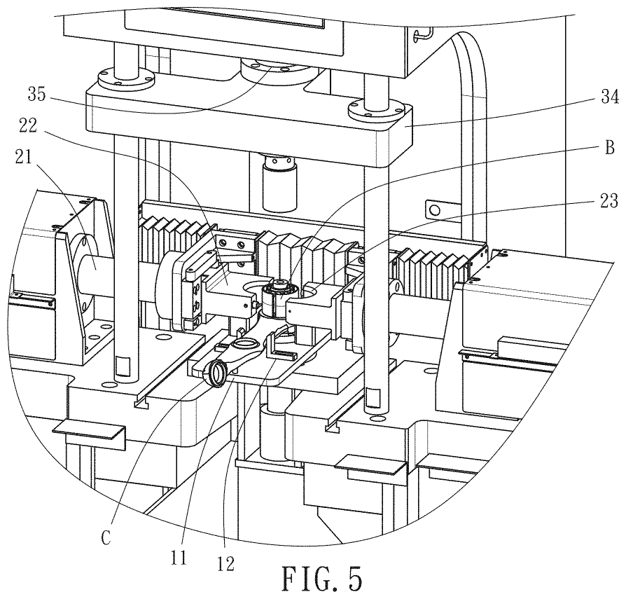

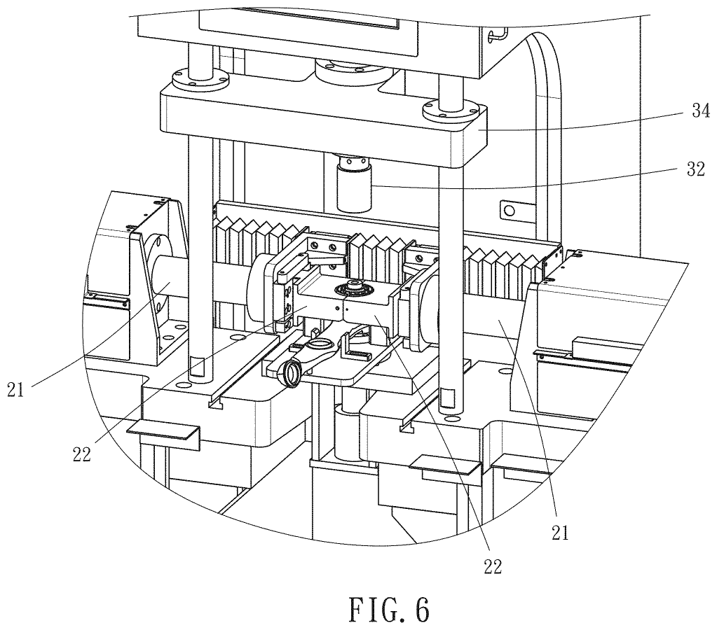

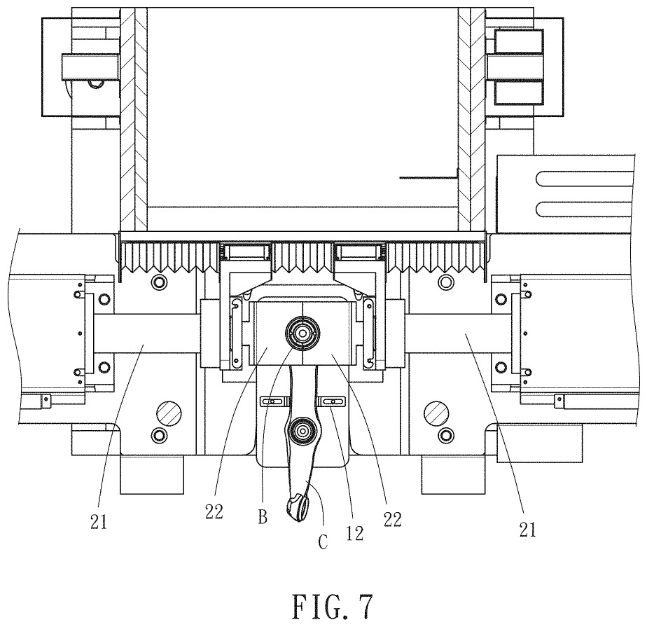

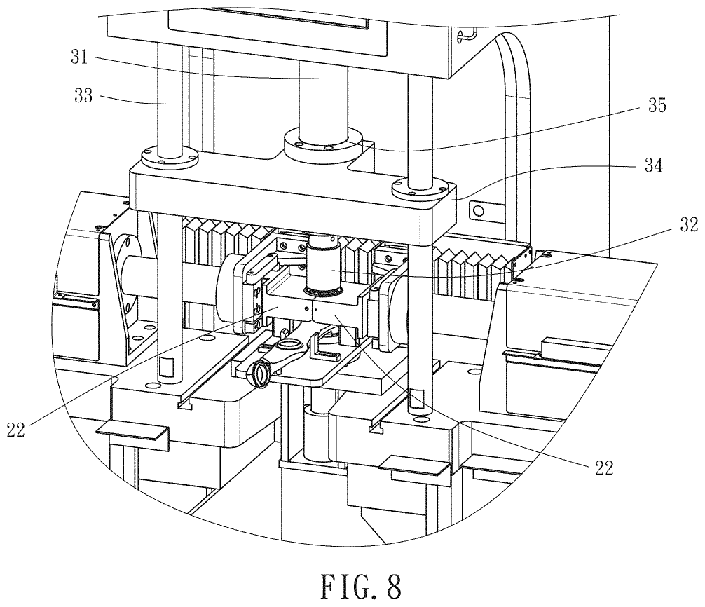

Referring to FIG. 1 through FIG. 8, a control arm assembly mechanism of the present disclosure comprises a workbench 10, two transversely pressing devices 20, and a vertically pressing device 30.

The workbench 10 has thereon a holder 11 for holding a target control arm C. The holder 11 has thereon two positioning blocking elements 12. The target control arm C is placed in a gap between the two positioning blocking elements 12. The workbench 10 has a through hole 13. A buffer cylinder 14 is disposed under the through hole 13. The buffer cylinder 14 comprises a cylinder body 15 and a rod body 16. The rod body 16 extends outward from the cylinder body 15 to reach the through hole 13.

The two transversely pressing devices 20 flank the workbench 10. The transversely pressing devices 20 each comprise a moving arm 21 capable of moving toward and away from the holder 11. A jig 22 is disposed at the front end of each moving arm 21. The jigs 22 each have a notch 23. The notches 23 correspond in shape to a target bushing. In this embodiment, the transversely pressing devices 20 are hydraulic cylinders, and the hydraulic cylinders each comprise a cylinder body and a piston rod. The jig 22 is disposed at the front end of each piston rod. The two piston rods flank the holder 11. The axes of the two piston rods are aligned on the same straight line. The two piston rods extend and thus approach the holder 11, thereby allowing the two jigs 22 to approach each other above the holder 11. The notches 23 of the jigs 22 have curved outlines. When the jigs 22 approach each other, the notches 23 together surround and squeeze the target bushing.

The vertically pressing device 30 is disposed above the workbench 10. The vertically pressing device 30 comprises a moving arm 31 capable of moving toward and away from the holder 11. In this embodiment, the vertically pressing device 30 is a stamping cylinder which comprises a cylinder body and a stamping rod. A punch 32 is disposed at the terminal end of the stamping rod and adapted to compress the bushing. The stamping rod is disposed above the through hole 13 of the workbench 10.

The movement axial direction of the moving arm 31 of the vertically pressing device 30 is preferably aimed at the through hole 13 of the workbench 10. The included angle between the movement axial direction of the moving arm 31 of the vertically pressing device 30 and each of the movement axial directions of the moving arms 21 of the two transversely pressing devices 20 is preferably 90 degrees.

The control arm assembly method whereby the control arm assembly mechanism of the present disclosure puts a control arm C and a bushing B together comprises the steps described below.

Step A: placing a target control arm C on the holder 11 of the workbench 10, causing the two positioning blocking elements 12 to abut against the two sides of the control arm C, respectively. A round hole of the control arm C, which a bushing is mounted on, is positioned above the through hole 13 of the workbench 10.

Step B: placing a bushing B on the round hole of the control arm C.

Step C: moving the moving arms 21 of the two transversely pressing devices 20 closer to the holder 11 and clamping the bushing B with the two jigs 22 to reduce the outer diameter of the bushing B clamped with the two jigs 22.

Step D: moving the moving arm 31 of the vertically pressing device toward the holder 11 and compressing the bushing B with the punch 32, thereby allowing the bushing B to be squeezed into the round hole of the control arm C.

Step E: moving the moving arm 31 of the vertically pressing device upward and causing the moving arms 21 of the two transversely pressing devices 20 to move leftward and rightward, respectively, and thus away from the holder 11, so as to finalize the assembly process.

The control arm assembly mechanism of the present disclosure simplifies a control arm assembly process by replacing a multiple-instance stamping procedure with one single clamping and stamping procedure. Therefore, the control arm assembly mechanism of the present disclosure reduces the time taken to perform processing and cuts the cost of manual operation, thereby attaining enhanced competitiveness.

To increase the stability of the vertically pressing device 30 in operation, the workbench 10 further has thereon two guide rods 33 and a guiding block 34. The two guide rods 33 are held vertically. The axes of the two guide rods 33 are parallel to the movement axial direction of the moving arm 31 of the vertically pressing device 30. The guiding block 34 is fitted to the two guide rods 33 and moves along the two guide rods 33. The guiding block 34 has a penetrating hole 35. The moving arm 31 of the vertically pressing device 30 penetrates the penetrating hole 35, such that the guiding block 34 moves in response to the movement of the moving arm 31. Under the guidance of the two guide rods 33, the moving arm 31 in motion shakes less and thus moves more steadily. In this embodiment, the guiding block 34 is fastened to the stamping rod. The guiding block 34 moves downward as soon as the stamping rod moves downward and squeezes the bushing B. The guiding block 34 moves upward and returns to its initial position as soon as the stamping rod retracts and returns to its initial position.

The power source for the vertically pressing device, the transversely pressing devices and the buffer cylinder of the present disclosure is hydraulic, pneumatic or electrical. In this embodiment, the power source is hydraulic for the sake of illustration, but the present disclosure is not limited thereto.

What is claimed is:

1. A control arm assembly mechanism, comprising:
a workbench having thereon a holder for holding a target control arm, wherein the workbench has a through hole under which a buffer cylinder is disposed;
a vertically pressing device disposed above the workbench and comprising a moving arm capable of moving toward and away from the holder, the moving arm being disposed above the through hole of the workbench; and
two transversely pressing devices flanking the workbench and each comprising a moving arm capable of moving toward and away from the holder, wherein a jig is disposed at a front end of each said moving arm, thereby allowing the two jigs to move toward and away from each other in response to the movement of the two moving arms.

2. The control arm assembly mechanism of claim 1, wherein a punch is disposed at a terminal end of the moving arm of the vertically pressing device.

3. The control arm assembly mechanism of claim 2, wherein the workbench further has two guide rods whose axes are parallel to a movement axial direction of the moving arm of the vertically pressing device.

4. The control arm assembly mechanism of claim 1, wherein the workbench further has a guiding block fitted to the two guide rods and having a penetrating hole penetrable by the moving arm of the vertically pressing device, thereby allowing the guiding block to move in response to the movement of the moving arm.

5. The control arm assembly mechanism of claim 1, wherein the holder has thereon two positioning blocking elements, and the target control arm is placed in a gap between the two positioning blocking elements.

6. A control arm assembly method for assembling a control arm with the control arm assembly mechanism of claim 1, comprising:
step A: placing a target control arm on a holder of the workbench;
step B: placing a bushing on the control arm;
step C: moving the moving arms of the two transversely pressing devices closer to the holder and clamping the bushing with the two jigs;
step D: moving the moving arm of the vertically pressing device toward the holder to press downward the bushing clamped by the two jigs, thereby allowing the bushing to be squeezed into the control arm; and
step E: moving the moving arm of the vertically pressing device upward, and moving the moving arms of the two transversely pressing devices leftward and rightward, respectively.

7. The control arm assembly method of claim 6, wherein the moving arms of the two transversely pressing devices move closer to the holder, and the bushing is clamped with the two jigs, thereby reducing the outer diameter of the bushing being clamped with the two jigs.

8. The control arm assembly method of claim 6, wherein, in step A, the control arm is placed on the holder of the workbench, and the holder has thereon two positioning blocking elements which abut against two sides of the control arm, respectively.

9. The control arm assembly method of claim 6, wherein, in step B, the control arm has a round hole above the through hole of the workbench, and the bushing is disposed above the round hole.
